(19) United States
(12) Patent Application Publication
(10) Pub. No.: US 2006/0103677 A1
(43) Pub. Date: May 18, 2006

(54) System and method for effectively performing arbitrary angle sprite rotation procedures

(76) Inventor: Jimmy Kwok Lap Lai, Vancouver (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/991,660

(22) Filed: Nov. 18, 2004

(51) Int. Cl. G09G 5/00

(52) U.S. Cl. 345/649

(57) ABSTRACT

A system and method for effectively performing arbitrary angle sprite rotation procedures includes a display controller with an input module that is configured to store an unrotated sprite into a sprite memory. The display controller also includes a sprite pipe that performs sprite rotation procedures upon the unrotated sprite to produce a rotated sprite at a selectable arbitrary rotation angle with respect to the unrotated sprite. The rotated sprite may then be presented together with main display data on a display device.

### BACKGROUND SECTION

1. Field of Invention

This invention relates generally to electronic display controller systems, and relates more particularly to a system and method for effectively performing arbitrary angle sprite rotation procedures.

2. Description of the Background Art

Implementing efficient methods for displaying electronic image data is a significant consideration for designers and manufacturers of contemporary electronic devices. However, efficiently displaying image data with electronic devices may create substantial challenges for system designers. For example, enhanced demands for increased device functionality and performance may require more system operating power and require additional hardware resources. An increase in power or hardware requirements may also result in a corresponding detrimental economic impact due to increased production costs and operational inefficiencies.

Furthermore, enhanced device capability to perform various advanced display control operations may provide additional benefits to a system user, but may also place increased demands on the control and management of various device components. For example, an enhanced electronic device that efficiently manipulates, transfers, and displays digital image data may benefit from an efficient implementation because of the large amount and complexity of the digital data involved.

Due to growing demands on system resources and substantially increasing data magnitudes, it is apparent that developing new techniques for controlling the display of electronic image data is a matter of concern for related electronic technologies. Therefore, for all the foregoing reasons, developing efficient systems for displaying electronic image data remains a significant consideration for designers, manufacturers, and users of contemporary electronic devices.

### SUMMARY

In accordance with the present invention, a system and method are disclosed for effectively performing arbitrary angle sprite rotation procedures. In certain embodiments, an electronic device may be implemented to include a central-processing unit (CPU), a display, and a display controller. In one embodiment, a sprite pipe of the display controller initially sets coordinates of a rotation reference point with reference to a lower left corner of an unrotated sprite stored in a sprite memory. Then, the sprite pipe sets the coordinates of the rotation reference point with reference to a lower left corner of a main image as displayed on the display.

The sprite pipe then calculates XStartHDE, XEndHDE, YStartVDE, and YEndVDE parameters for a rotated sprite with reference to a main image on the display. Next, the sprite pipe calculates XStartIG, XEndIG, YStartIG, and YEndIG parameters for the rotated sprite with reference to the unrotated sprite. The sprite pipe then initializes a display HCount value, a display VCount value, a sprite HDE, and sprite VDE to zero. The sprite pipe also sets a sprite HCount value equal to the XStart IG parameter and a sprite VCount value equal to the YStartIG parameter.

The sprite pipe then determines whether the display VCount value is greater than or equal to the YStartVDE parameter while simultaneously being less than or equal to the YEndVDE parameter. If the display VCount value is greater than or equal to the YStartVDE parameter while simultaneously being less than or equal to the YEndVDE parameter, then the sprite pipe sets the sprite VDE equal to one. Next, the sprite pipe determines whether the display HCount value is greater than or equal to the XStartHDE parameter while simultaneously being less than or equal to the XEndHDE parameter. If the display HCount value is greater than or equal to the XStartHDE parameter while simultaneously being less than or equal to the XEndHDE parameter, then the sprite pipe sets the sprite HDE equal to one.

Next, the sprite pipe determines whether both the sprite HDE and the sprite VDE are simultaneously equal to one. If the sprite HDE and sprite VDE are not both equal to one, then the display controller provides a current pixel from the main image for presentation upon the display. However, if the sprite HDE and the sprite VDE are both equal to one, then the sprite pipe utilizes the sprite HCount value and the sprite VCount value to perform a backward rotation calculation to exactly align pixels in the rotated sprite with corresponding pixels of the display.

The sprite pipe then determines whether the result of the foregoing backward rotation calculation is within the unrotated sprite. If the result of the backward rotation calculation is not within the unrotated sprite, then the display controller provides a current pixel from the main image for presentation upon the display. However, if the result of the backward rotation calculation is within the unrotated sprite, then according to the foregoing backward rotation result, the sprite pipe performs a rendering procedure to fetch and send an appropriate sprite pixel to the display.

Next, the sprite pipe increments the sprite HCount. The sprite pipe then determines whether the end of a current display line has been reached. If the end of a current display line has been reached, then the sprite pipe resets the display HCount value to zero, and sets the sprite HCount value equal to the XStart IG parameter. However, if the end of a current display line has not been reached, then the sprite pipe increments the display HCount value.

The sprite pipe next determines whether the end of a current display frame has been reached. If the end of the current display frame has not been reached, then the sprite pipe increments the display VCount value and the sprite VCount value, and the process returns to process addition data. However, if the end of the display frame has been reached, then the process may terminate. For at least the foregoing reasons, the present invention therefore provides an improved system and method for effectively performing arbitrary angle sprite rotation procedures.

### BRIEF DESCRIPTION OF THE DRAWINGS

FIG. 1 is a block diagram for one embodiment of an electronic device, in accordance with the present invention;

FIG. 2 is a block diagram for one embodiment of the display controller of FIG. 1, in accordance with the present invention;

FIG. 3 is a block diagram for one embodiment of the video memory of FIG. 2, in accordance with the present invention;

FIG. 4 is a block diagram for one embodiment of the controller registers of FIG. 2, in accordance with the present invention;

FIG. 5 is a block diagram for one embodiment of the display of FIG. 1, in accordance with the present invention;

FIG. 6 is a drawing illustrating a procedure for calculating horizontal display enable parameters and vertical display enable parameters, in accordance with one embodiment of the present invention;

FIG. 7 is a drawing illustrating a procedure for calculating horizontal image generation parameters and vertical image generation parameters, in accordance with one embodiment of the present invention; and

FIGS. 8A, 8B, and 8C are a flowchart of method steps for performing arbitrary angle sprite rotation procedures, in accordance with one embodiment of the present invention.

### DETAILED DESCRIPTION

The present invention relates to an improvement in display controller systems. The following description is presented to enable one of ordinary skill in the art to make and use the invention, and is provided in the context of a patent application and its requirements. Various modifications to the embodiments disclosed herein will be apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for effectively performing arbitrary angle sprite rotation procedures, and includes a display controller with an input module that is configured to store an unrotated sprite into a sprite memory. The display controller also includes a sprite pipe that performs sprite rotation procedures upon the unrotated sprite to produce a rotated sprite at a selectable arbitrary rotation angle with respect to the unrotated sprite. The rotated sprite may then be presented together with main display data on a display device.

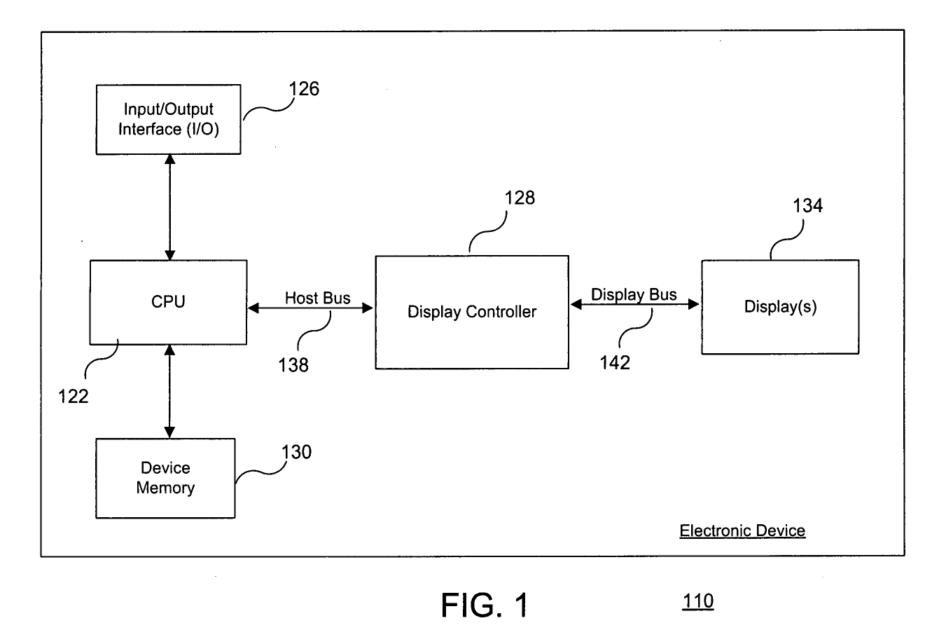

Referring now to FIG. 1, a block diagram for one embodiment of an electronic device 110 is shown, according to the present invention. The FIG. 1 embodiment includes, but is not limited to, a central processing unit (CPU) 122, an input/output interface (I/O) 126, a display controller 128, a device memory 130, and one or more display(s) 134. In alternate embodiments, electronic device 110 may include elements or functionalities in addition to, or instead of, certain of the elements or functionalities discussed in conjunction with the FIG. 1 embodiment.

In the FIG. 1 embodiment, CPU 122 may be implemented as any appropriate and effective processor device or microprocessor to thereby control and coordinate the operation of electronic device 110 in response to various software program instructions. In the FIG. 1 embodiment, device memory 130 may comprise any desired storage-device configurations, including, but not limited to, random access memory (RAM), read-only memory (ROM), and storage devices such as removable memory or hard disk drives. In the FIG. 1 embodiment, device memory 130 may include, but is not limited to, a device application of program instructions that are executed by CPU 122 to perform various functions and operations for electronic device 110. The particular nature and functionality of the device application typically varies depending upon factors such as the type and specific use of the corresponding electronic device 110.

In the FIG. 1 embodiment, the foregoing device application may include program instructions for allowing CPU 122 to provide image data and corresponding transfer and display information via host bus 138 to display controller 128. In accordance with the present invention, display controller 128 then responsively provides the received image data via display bus 142 to at least one of the display(s) 134 of electronic device 110. In the FIG. 1 embodiment, input/output interface (I/O) 126 may include one or more interfaces to receive and/or transmit any required types of information to or from electronic device 110. Input/output interface 126 may include one or more means for allowing a device user to communicate with electronic device 110. In addition, various external electronic devices may communicate with electronic device 110 through I/O 126. For example, a digital imaging device, such as a digital camera, may utilize input/output interface 126 to provide captured image data to electronic device 110.

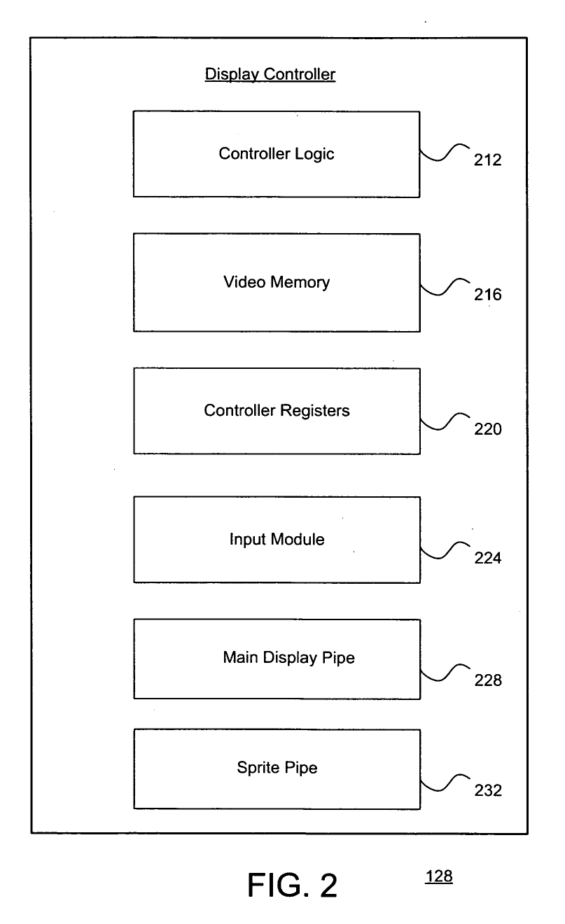

In the FIG. 1 embodiment, electronic device 110 may advantageously utilize display controller 128 for efficiently managing various operations and functionalities relating to display(s) 134. The implementation and functionality of display controller 128 is further discussed below in conjunction with FIGS. 2-4 and 6-9. In the FIG. 1 embodiment, electronic device 110 may be implemented as any desired type of electronic device or system. For example, in certain embodiments, electronic device 110 may alternately be implemented as a cellular telephone, a personal digital assistant device, an electronic imaging device, or a computer device. Various embodiments for the operation and utilization of electronic device 110 are further discussed below in conjunction with FIGS. 2-9.

Referring now to FIG. 2, a block diagram for one embodiment of the FIG. 1 display controller 128 is shown, in accordance with the present invention. The FIG. 2 embodiment includes, but is not limited to, controller logic 212, video memory 216, controller registers 220, an input module 224, a main display pipe 228, and a sprite pipe 232. In alternate embodiments, display controller 128 may include elements or functionalities in addition to, or instead of, certain of the elements or functionalities discussed in conjunction with the FIG. 2 embodiment.

In the FIG. 2 embodiment, display controller 128 may be implemented as an integrated circuit device that accepts image data and corresponding transfer and display information from CPU 122 (FIG. 1). Display controller 128 then automatically provides the received image data to display 134 of electronic device 110 in an appropriate and efficient manner for displaying to a device user. In the FIG. 2 embodiment, controller logic 212 manages and coordinates the overall operation of display controller 128.

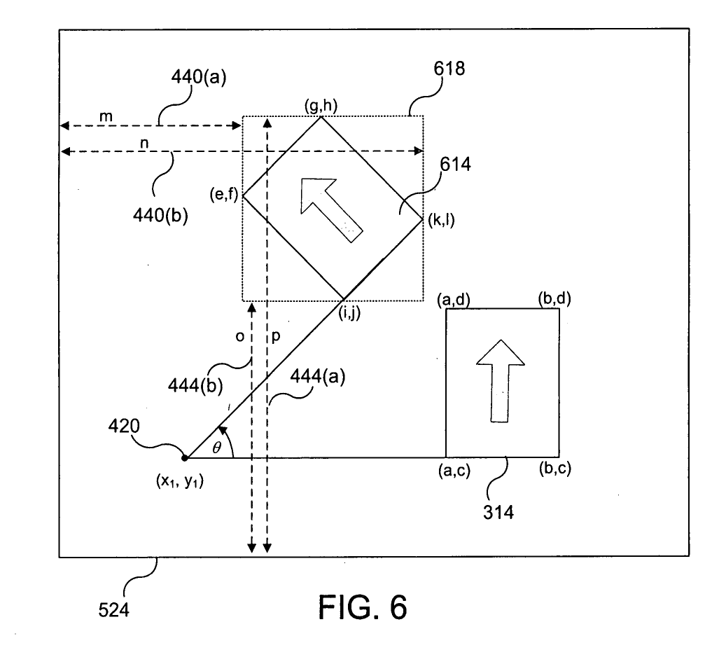

In the FIG. 2 embodiment, display controller 128 may utilize controller registers 220 to store various types of configuration, control and status information. In the FIG. 2 embodiment, display controller 128 may utilize input module 224 to write various types of information and input data into video memory 216 during corresponding write operations. Similarly, display controller 128 may utilize main display pipe 228 to read various types of information and main output data from video memory 216 during corresponding read operations for presentation upon a main window on display 134 (FIG. 1). In accordance with the present invention, display controller 128 may utilize sprite pipe 232 to perform various types of arbitrary angle sprite rotation procedures that are further discussed below in conjunction with FIGS. 6, 7, and 8A-C.

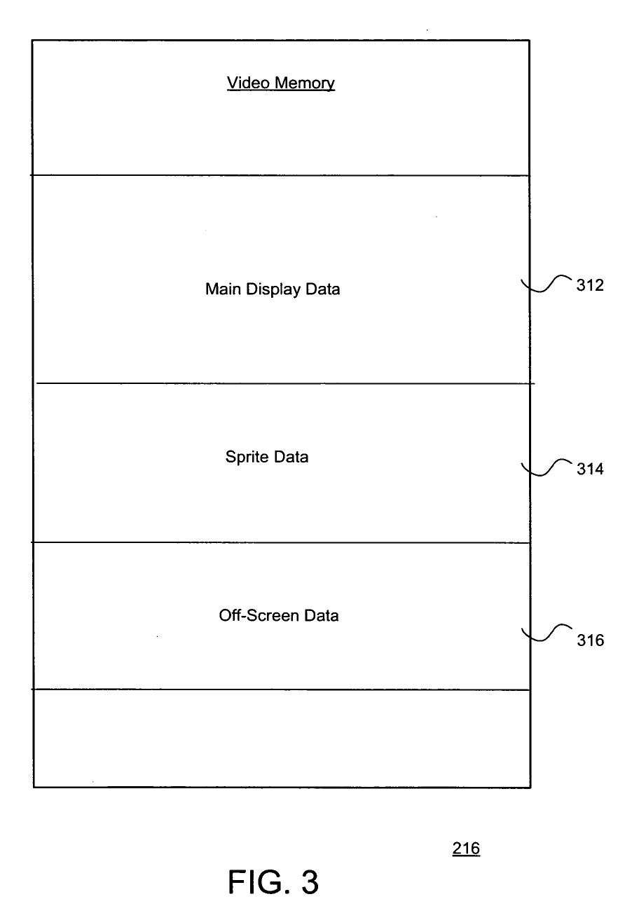

Referring now to FIG. 3, a block diagram for one embodiment of the FIG. 2 video memory 216 is shown, in accordance with the present invention. In the FIG. 3 embodiment, video memory 216 includes, but is not limited to, main display data 312, sprite data 314, and off-screen data 316. In alternate embodiments, video memory 216 may include elements and functionalities in addition to, or instead of, certain of the elements and functionalities discussed in conjunction with the FIG. 3 embodiment.

In the FIG. 3 embodiment, video memory 216 may be implemented by utilizing any effective types of memory devices or configurations. For example, in certain embodiments, video memory 216 may be implemented as a random-access memory (RAM) device. In the FIG. 3 embodiment, input module 224 or another appropriate entity writes main display data 312 into video memory 216 for subsequent transfer by to a main window area on a screen of display 134 of electronic device 110 for viewing by a device user. In the FIG. 3 embodiment, sprite data 314 may include any desired type of image data for presentation on display 134 in conjunction with main display data 312. For example, sprite data 314 may include image data representing a display cursor, a gaming object, a display icon, or any desired visual element for display in conjunction with main display data 312.

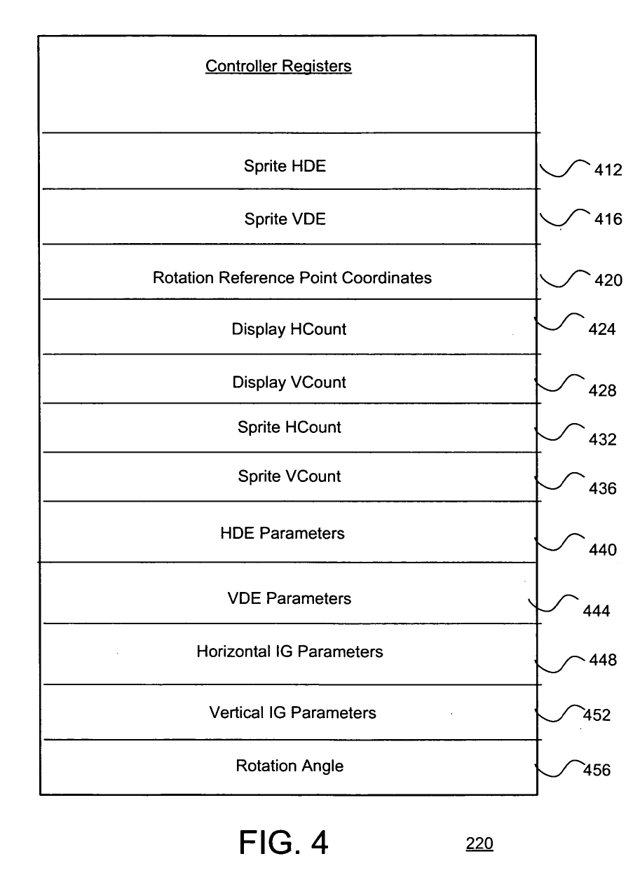

In the FIG. 3 embodiment, off-screen data 316 may include any appropriate type of information or data that is not intended for presentation upon display 134 of electronic device 110. For example, off-screen data 316 may be utilized to cache certain fonts or other objects for use by display controller 128. In accordance with the present invention, arbitrary angle rotation procedures for sprite data 314 are further discussed below in conjunction with FIGS. 4, 6, 7, and 8A-8C.

Referring now to FIG. 4, a block diagram for one embodiment of the FIG. 2 controller registers 220 is shown, in accordance with the present invention. In the FIG. 4 embodiment, controller registers 220 include, but are not limited to, a sprite horizontal display enable (HDE) 412, a sprite vertical display enable (VDE) 416, rotation reference point coordinates 420, a display HCount 424, a display VCount 428, a sprite HCount 432, a sprite VCount 436, horizontal display enable (HDE) parameters 440, vertical display enable (VDE) parameters 444, horizontal image generation (IG) parameters 448, vertical image generation (IG) parameters 452, and a rotation angle 456. In alternate embodiments, controller registers 220 may include elements and functionalities in addition to, or instead of, certain of the elements and functionalities discussed in conjunction with the FIG. 4 embodiment.

In the FIG. 4 embodiment, HDE parameters 440 may include an XStartHDE parameter and an XEndHDE parameter. VDE parameters 444 may include a YStartVDE parameter and a YEndVDE parameter. In the FIG. 4 embodiment, horizontal IG parameters 448 may include an XStartIG parameter and an XEndIG parameter. Vertical IG parameters 452 may include a YStartIG parameter and a YEndIG parameter.

In the FIG. 4 embodiment, rotation angle 456 specifies the number of degrees that sprite data 314 (FIG. 3) is rotated when displayed upon display 134 (FIG. 1). In accordance with the present invention, display controller 128 may support any desired rotation angle 456 from zero to 360 degrees, and is therefore not limited to multiples of ninety degrees. The derivation and utilization of sprite HDE 412, sprite VDE 416, rotation reference point coordinates 420, display HCount 424, display VCount 428, sprite HCount 432, sprite VCount 436, HDE parameters 440, VDE parameters 444, horizontal IG parameters 448, vertical IG parameters 452, and rotation angle 456 are further discussed below in conjunction with FIGS. 6, 7, and 8A-8C.

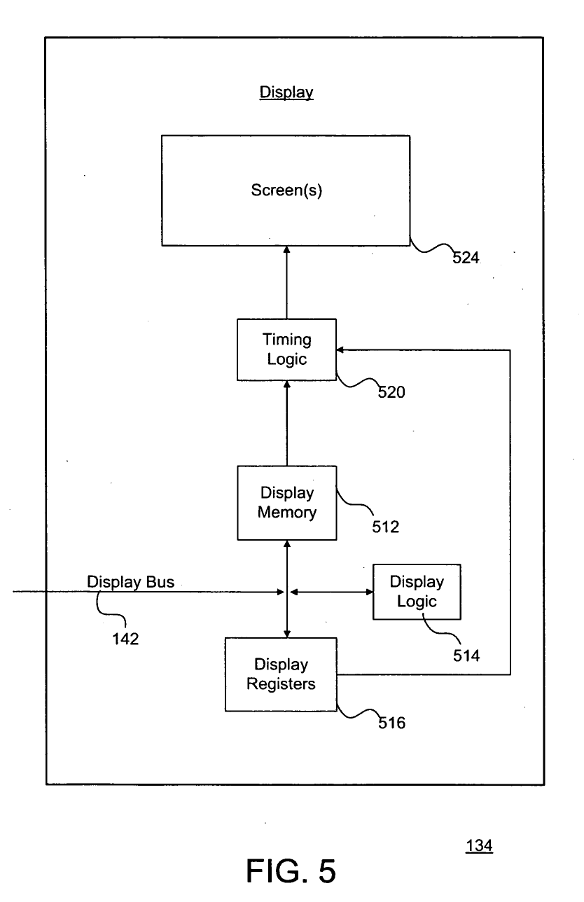

Referring now to FIG. 5, a block diagram for one embodiment of the FIG. 1 display 134 is shown, in accordance with the present invention. In the FIG. 5 embodiment, display 134 includes, but is not limited to, a display memory 512, display logic 514, display registers 516, timing logic 520, and one or more screen(s) 524. In alternate embodiments, display 134 may include elements and functionalities in addition to, or instead of, certain of the elements and functionalities discussed in conjunction with the FIG. 5 embodiment.

In the FIG. 5 embodiment, display 134 is implemented as a random-access-memory based liquid-crystal display panel (RAM-based LCD panel). However, in alternate embodiments, display 134 may be implemented by utilizing any type of appropriate display technologies or configurations. In the FIG. 5 embodiment, display controller 128 provides various types of display information to display registers 516 via display bus 142. Display registers 516 may then utilize the received display information for effectively controlling timing logic 520. In the FIG. 5 embodiment, display logic 514 manages and coordinates data transfer and display functions for display 134.

In the FIG. 5 embodiment, display controller 128 provides image data from display buffer 312 (FIG. 3) to display memory 512 via display bus 142. In the FIG. 5 embodiment, display memory 512 is typically implemented as random-access memory (RAM). However, in various other embodiments, any effective types or configurations of memory devices may be utilized to implement display memory 512. In the FIG. 5 embodiment, display memory 512 then advantageously provides the image data received from display controller 128 to one or more screens 524 via timing logic 520 for viewing by a device user of electronic device 110.

Referring now to FIG. 6, a drawing illustrating a procedure for calculating horizontal display enable parameters 440 and vertical display enable parameters 444 is shown. The example shown in FIG. 6 is presented for purposes of illustration, and in alternate embodiments, the present invention may implement compression storage information by utilizing configurations and techniques in addition to, or instead of, certain of those configurations and techniques shown in the embodiment of FIG. 6

In the FIG. 6 embodiment, an unrotated sprite 314 is shown with corner coordinates of (a,d), (b,d), (a,c), and (b,c). A rotated sprite 614 is also shown with corner coordinates of (e,f), (g,h), (i,j), and (k,l). In the FIG. 6 embodiment, the rotated sprite 614 is shown rotated by a selectable and arbitrary rotation angle θ with reference to rotation reference point coordinates (x₁, y₁) 420 upon screen 524 of display 134 (FIG. 1). In accordance with the present invention, rotation reference point coordinates (x₁, y₁) 420 may be selected to be anywhere either inside or outside of unrotated sprite 314.

Rotated sprite 614 is bordered by a rectangular active sprite area 618 that is defined by the corner coordinates (e,f), (g,h), (i,j), and (k,l) of rotated sprite 614. In particular, an XStartHDE parameter 440(a) defines a left boundary of active sprite area 618, and an XEndHDE parameter 440(b) defines a right boundary of active sprite area 618. Similarly, a YStartVDE parameter 444(a) defines a top boundary of active sprite area 618, and a YEndVDE parameter 444(b) defines a bottom boundary of active sprite area 618.

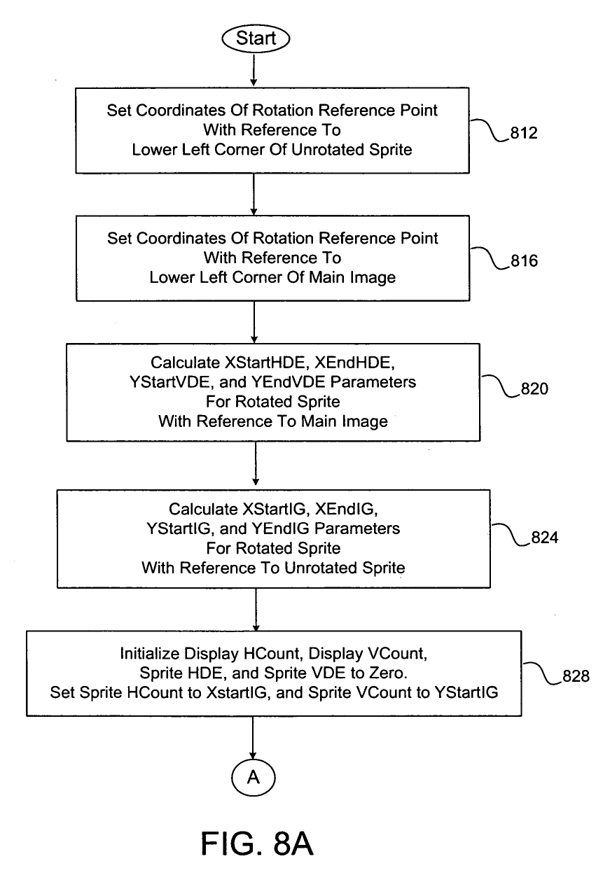

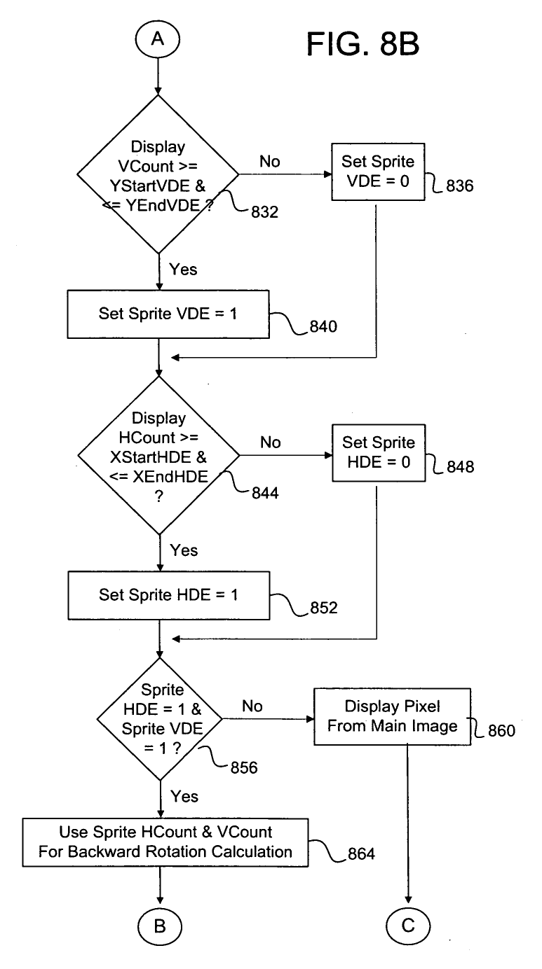

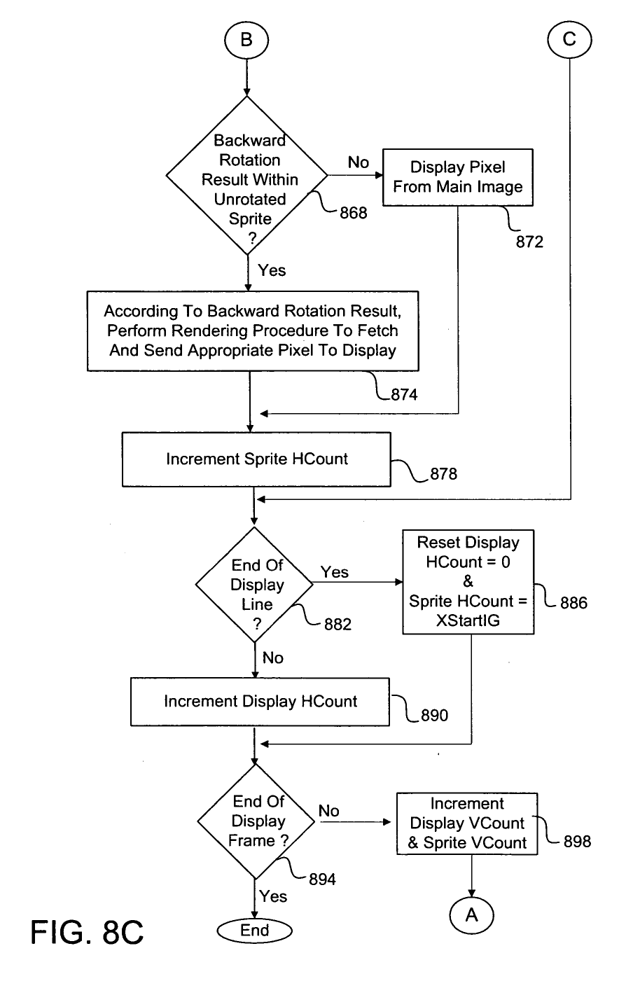

In the FIG. 6 example, sprite pipe 232 (FIG. 2) may perform calculation procedures to derive XStartHDE parameter 440(a), XEndHDE parameter 440(b), YStartVDE parameter 444(a), and YEndVDE parameter 444(b) according to the following formulas:
a=X-Start of the un-rotated sprite
b=X-End of the un-rotated sprite
c=Y-Start of the un-rotated sprite
d=Y-End of the un-rotated sprite
(e,f)=coordinates of the rotated upper-left corner of the sprite
(g,h)=coordinates of the rotated upper-right corner of the sprite
(i,j)=coordinates of the rotated lower-left corner of the sprite
(k,l)=coordinates of the rotated lower-right corner of the sprite
m=X-Start of the rotated sprite
n=X-End of the rotated sprite
o=Y-Start of the rotated sprite
p=Y-End of the rotated sprite
then
e=a*cos θ−d*sin θ+x₁*(1−cos θ)+y₁*sin θ
f=a*sin θ+d*cos θ+y₁*(1−cos θ)−x₁* sin θ
g=b*cos θ−d*sin θ+x₁*(1−cos θ)+y₁*sin θ
h=b*sin θ+d*cos θ+y₁*(1−cos θ)−x₁*sin θ
i=a*cos θ−c*sin θ+x₁*(1−cos θ)+y₁*sin θ
j=a*sin θ+c*cos θ+y₁*(1−cos θ)−x₁*sin θ
k=b*cos θ−c*sin θ+x₁*(1−cos θ)+y₁*sin θ
l=b*sin θ+c*cos θ+y₁*(1−cos θ)−x₁*sin θ
m=floor(min(e, g, i, k))
m=ceil(max(e, g, i, k))
o=floor(min(f, h, j, l))
p=ceil(max(f, h, j, l)
where the function floor( ) is rounding down to the nearest integer, and the function ceil( ) is rounding up to the nearest integer. In accordance with the present invention, sprite pipe 232 recalculates XStartHDE parameter 440(a), XEndHDE parameter 440(b), YStartVDE parameter 444(a), and YEndVDE parameter 444(b) each time that rotation angle θ is changed. The utilization of XStartHDE parameter 440(a), XEndHDE parameter 440(b), YStartVDE parameter 444(a), and YEndVDE parameter 444(b) is further discussed below in conjunction with FIG. 8A.

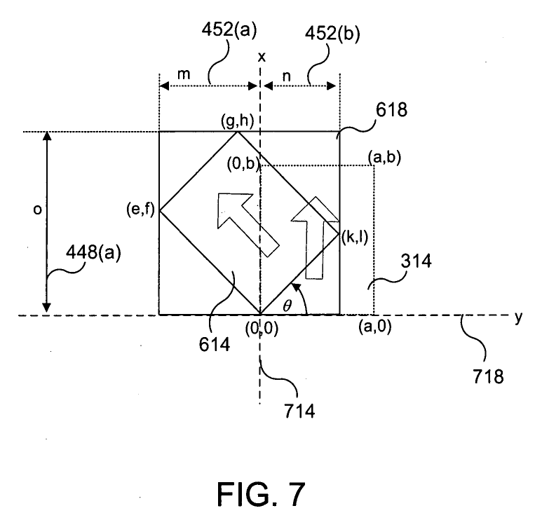

Referring now to FIG. 7, a drawing illustrating a procedure for calculating horizontal image generation parameters 448 and vertical image generation parameters 452 is shown. The FIG. 7 embodiment is presented for purposes of illustration, and in alternate embodiments, the present invention may utilize rotation memories that include configurations and elements in addition to, or instead of, certain of the configurations and elements discussed in conjunction with the FIG. 7 embodiment.

In the FIG. 7 embodiment, an unrotated sprite 314 is shown with corner coordinates of (0,b), (a,b), (0,0), and (a,0) upon a graph with a vertical X axis 714 and a horizontal Y axis 718. A rotated sprite 614 is also shown with corner coordinates of (e,f), (g,h), (0,0), and (k,l). Rotated sprite 614 is therefore positioned and rotated upon the lower left corner coordinates (0,0) of unrotated sprite 314. In the FIG. 7 embodiment, the rotated sprite 614 is shown rotated by a selectable and arbitrary rotation angle θ with reference to rotation reference point coordinates (0,0) which also form the origin of X axis 714 and Y axis 718.

Rotated sprite 614 is bordered by a rectangular active sprite area 618 that is defined by the corner coordinates (e,f), (g,h), (0,0), and (k,l) of rotated sprite 614. In particular, an XStartIG parameter 452(a) defines a left boundary of active sprite area 618, and an XEndIG parameter 452(b) defines a right boundary of active sprite area 618. Similarly, a YStartIG parameter 448(a) defines a top boundary of active sprite area 618. In the FIG. 7 embodiment, a YEndIG parameter coincides with Y axis 718, and is therefore equal to zero.

In the FIG. 7 example, sprite pipe 232 (FIG. 2) may perform calculation procedures to derive XStartIG parameter 452(a), XEndIG parameter 452(b), YStartIG parameter 448(a), and the YEndIG parameter according to the following formulas:
a=width of the un-rotated sprite
b=height of the un-rotated sprite
(e,f)=coordinates of the rotated upper-left corner of the sprite
(g,h)=coordinates of the rotated upper-right corner of the sprite
(k,l)=coordinates of the rotated lower-right corner of the sprite
m=X-Start of the rotated sprite
n=X-End of the rotated sprite
o=Y-Start of the rotated sprite
p=Y-End of the rotated sprite
then

$$\begin{matrix}e = 0 * cos θ - b * sin θ \\ = - b * sin θ\end{matrix}$$

$$\begin{matrix}f = 0 * sin θ + d * cos θ \\ = d * cos θ\end{matrix}$$

$$g = a * cos θ - b * sin θ$$

$$h = a * sin θ + b * cos θ$$

$$\begin{matrix}k = a * cos θ - 0 * sin θ \\ = a * cos θ\end{matrix}$$

$$\begin{matrix}l = a * sin θ + 0 * sin θ \\ = a * sin θ\end{matrix}$$

m=floor(min(e, g, 0, k))
n=ceil(max(e, g, 0, k))
o=floor(min(f, h, 0, l))
p=ceil(max(f, h, 0, l))
where the function floor( ) is rounding down to the nearest integer, and the function ceil( ) is rounding up to the nearest integer. In accordance with the present invention, sprite pipe 232 recalculates XStartIG parameter 452(a), XEndIG parameter 452(b), and YStartVDE parameter 448(a) each time that rotation angle θ is changed. The utilization of XStartIG parameter 452(a), XEndIG parameter 452(b), and YStartVDE parameter 448(a) is further discussed below in conjunction with FIG. 8A.

In certain embodiments, after sprite pipe 232 performs a forward rotation procedure to produce a forward-rotated sprite, individual pixels of the forward-rotated sprite may not align with corresponding pixels of the main image (main display data 312) on display 134. Sprite pipe 232 may then perform a backward rotation procedure to exactly align individual pixels of rotated sprite 614. A horizontal counter may provide a HCount value that is treated as the X coordinate of target output pixels. Similarly, a vertical counter may provide a VCount value that is treated as the Y coordinate of target output pixels. The HCount value is counted from XStartIG 452(a) of rotated sprite 614 to XEndIG 452(b) of rotated sprite 614. The VCount value is counted from YStartIG 448(a) of rotated sprite 614.

In certain embodiments, in order to determine which source pixels make up the target output pixel (x′,y′), a backward rotation calculation may be performed according to the following formulas:

$$\begin{matrix}x = {x}^{′} * cos ( - θ ) - {y}^{′} * sin ( - θ ) \\ {x}^{′} * cos θ + {y}^{′} * sin θ\end{matrix}$$

$$\begin{matrix}y = {x}^{′} * sin ( - θ ) + {y}^{′} * cos ( - θ ) \\ = - {x}^{′} * sin θ - {y}^{′} * cos θ\end{matrix}$$

In certain instances, the x and y values obtained from the foregoing backward rotation calculations may be non-integers which indicates that target output pixels consist of more than one source pixel. Sprite pipe 232 may therefore perform appropriate rendering procedures to render the final output pixels for rotated sprite 614. One rendering technique simply selects the closest source pixel according to the following formulas:
x″=x′*cos θ+y′*sin θ
x=round(x″)
y″=−x′*sin θ−y′*cos θ
y=round(y″)
where the function round( ) is rounding to the closest integer.

Another rendering technique is to calculate a weighted sum of all source pixels. Normally the target pixel will be made up of four adjacent source pixels, and these source pixels are:
(a,b), (c,d), (e,f), and (g,h)
   where
   a=floor(x″)
   b=floor(y″)
   c=ceil(x″)
   d=floor(y″)
   e=floor(x″)
   f=ceil(y″)
   g=ceil(x″)
   h=ceil(y″)
   Then, the value of each color component of the target output pixels may be calculated as:
   Red(output)=[(x″−a)*Red((c,d))+(1−x″−a)*Red((a,b))]*(y″−b)+[(x″−a)*Red((g,h))+(1−x″−a)*red((e,f))]*(1−y″−b)
   Grn(output)=[(″−a)*Grn((c,d))+(1−x″−a)*Grn((a,b))]*(y″−b)+[(x″−a)*Grn((g,h))+(1−x″−a)*Grn((e,f))]*(1−y″−b)
   Blu(output)=[(x″−a)*Blu((c,d))+(1−x″−a)*Blu((a,b))]*(y″−b)+[(x″−a)*Blu((g,h))+(1−x″−a)*Blu((e,f))]*(1−y″−b)
   where the function Red( ) returns the value of the red color component of the particular pixel, Grn( ) returns the value of the green color component, and Blu( ) returns the value of the blue color component. The implementation of the foregoing techniques to perform arbitrary angle sprite rotation procedures is further discussed below in conjunction with FIGS. 8A, 8B, and 8C.

Referring now to FIGS. 8A, 8B, and 8C, a flowchart of method steps for performing arbitrary angle sprite rotation procedures is shown, in accordance with one embodiment of the present invention. The flowchart of FIGS. 8A, 8B, and 8C is presented for purposes of illustration, and in alternate embodiments, the present invention may utilize steps and sequences in addition to, or instead of, certain of the steps and sequences discussed in conjunction with the embodiment shown in FIGS. 8A, 8B, and 8C.

In the FIG. 8 embodiment, in step 812, a sprite pipe 232 (FIG. 2) of a display controller 128 (FIG. 1) initially sets coordinates of a rotation reference point 420 with reference to a lower left corner of an unrotated sprite 314. Then, in step 816, sprite pipe 232 sets the coordinates of the rotation reference point 420 with reference to a lower left corner of a main image on a display 134 (FIG. 1).

In step 820, sprite pipe 232 calculates XStartHDE, XEndHDE, YStartVDE, and YEndVDE parameters for a rotated sprite 614 with reference to the main image on display 134. Next, in step 824, sprite pipe 232 calculates XStartIG, XEndIG, YStartIG, and YEndIG parameters for rotated sprite 614 with reference to the unrotated sprite 314. In step 828, sprite pipe 232 initializes display HCount 424, display VCount 428, sprite HDE 412, and sprite VDE to a zero value. Sprite pipe 232 also sets sprite HCount 432 and sprite VCount 436 to XStartIG parameter 452(a).

In step 832, sprite pipe 232 determines whether display VCount 428 is greater than or equal to YStartVDE 444(a) while simultaneously being less than or equal to YEndVDE 444(b). If display VCount 428 is greater than or equal to YStartVDE 444(a) while simultaneously being less than or equal to YEndVDE 444(b), then sprite pipe 232 sets sprite VDE 416 equal to one. Then, in step 844, sprite pipe 232 determines whether display HCount 424 is greater than or equal to XStartHDE 440(a) while simultaneously being less than or equal to XEndHDE 440(b). If display HCount 424 is greater than or equal to XStartHDE 440(a) while simultaneously being less than or equal to XEndHDE 440(b), then in step 852, sprite pipe 232 sets sprite HDE 412 equal to one.

In step 856, sprite pipe 232 determines whether both sprite HDE 412 and sprite VDE 416 are simultaneously equal to one. If sprite HDE 412 and sprite VDE 416 are not both equal to one, then in step 860, display controller 128 provides a current pixel from the main image data 312 for presentation upon display 134. However, if sprite HDE 412 and sprite VDE 416 are both equal to one, then in step 864, sprite pipe 232 utilizes sprite HCount 432 and sprite VCount 436 to perform a backward rotation calculation to align pixels in rotated sprite 614 with pixels of display 134.

In step 868, sprite pipe 232 determines whether the result of the foregoing backward rotation calculation is within the unrotated sprite 314. If the result of the backward rotation calculation is not within the unrotated sprite 314, then in step 872, display controller 128 provides a current pixel from the main image data 312 for presentation upon display 134. However, if the result of the backward rotation calculation is within the unrotated sprite 314, then in step 874, according to the foregoing backward rotation result, sprite pipe 232 performs a rendering procedure to fetch and send an appropriate pixel to display 134.

In step 878, sprite pipe 232 increments sprite HCount 432. Then, in step 882, sprite pipe 232 determines whether the end of a current display line has been reached. If the end of a current display line has been reached, then in step 886, sprite pipe 232 resets display HCount 424 to zero, sets sprite HCount 432 to equal XStart IG parameter 452(a), and advances to step 894. However, if the end of a current display line has not been reached, then in step 890, sprite pipe 232 increments display HCount 424.

In step 894, sprite pipe 232 determines whether the end of a current display frame has been reached. If the end of the current display frame has not been reached, then in step 898, sprite pipe 232 increments display VCount 428 and sprite VCount 436, and the FIG. 8 process returns to step 832 for processing addition data. However, in step 894, if the end of the display frame has been reached, then the FIG. 8 process may terminate. In certain embodiments, a hardware implementation of the present invention may efficiently utilize a lookup table to store pre-calculated sine and cosine values for performing the foregoing calculations. For at least the foregoing reasons, the present invention therefore provides an improved system and method for effectively performing arbitrary angle sprite rotation procedures.

The invention has been explained above with reference to certain preferred embodiments. Other embodiments will be apparent to those skilled in the art in light of this disclosure. For example, the present invention may be implemented using certain configurations and techniques other than those described in the embodiments above. Additionally, the present invention may effectively be used in conjunction with systems other than those described above as the preferred embodiments. Therefore, these and other variations upon the foregoing embodiments are intended to be covered by the present invention, which is limited only by the appended claims.

What is claimed is:

1. A system for performing sprite rotation procedures in an electronic device, comprising:
an input module configured to store an unrotated sprite into a sprite memory; and
a sprite pipe that performs said sprite rotation procedures upon said unrotated sprite to produce a rotated sprite at a selectable arbitrary rotation angle with respect to said unrotated sprite.

2. The system of claim 1 wherein said input module and said sprite pipe are implemented in a display controller that coordinates providing image data to a display device, said display controller being implemented as an integrated circuit device that functions as an interface between a central processing unit and said display device.

3. The system of claim 1 wherein said sprite pipe provides said rotated sprite to a data destination that includes a display for a portable electronic device.

4. The system of claim 3 wherein said portable electronic device is implemented as a portable cellular telephone device.

5. The system of claim 1 wherein said unrotated sprite and said rotated sprite represent a cursor inserted in main display data on a display device.

6. The system of claim 1 wherein said rotated sprite is rotated with respect to rotation point coordinates that are selectably positionable to be inside or outside of said unrotated sprite.

7. The system of claim 1 wherein said unrotated sprite and said rotated sprite represent a gaming object inserted in main display data on a display device.

8. The system of claim 1 wherein said sprite pipe sets a horizontal display enable and a vertical display enable for enabling said sprite rotation procedures in said electronic device.

9. The system of claim 1 wherein said sprite pipe calculates vertical display enable parameters that define vertical boundaries of a rectangular active sprite area with reference to main display data, said rectangular active sprite area encompassing said rotated sprite, said sprite pipe also calculating horizontal display enable parameters that define horizontal boundaries of said rectangular active sprite area.

10. The system of claim 1 wherein said sprite pipe calculates vertical image generation parameters that define vertical boundaries of a rectangular active sprite area with reference to said unrotated sprite, said rectangular active sprite area encompassing said rotated sprite, said sprite pipe also calculating horizontal image generation parameters that define horizontal boundaries of said rectangular active sprite area.

11. The system of claim 1 wherein said sprite pipe sets a rotation reference point for performing said sprite rotation procedures, said rotation reference point being set with reference to a lower left corner of said unrotated sprite, and with reference to a lower left corner of main display data.

12. The system of claim 1 wherein said sprite pipe calculates an XStartHDE parameter, an XEndHDE parameter, a YStartVDE parameter, and a YEndVDE parameter to define four sides of a rectangular active sprite area that bounds said rotated sprite with reference to main display data.

13. The system of claim 1 wherein said sprite pipe calculates an XStartIG parameter, an XEndIG parameter, a YStartIG parameter, and a YEndIG parameter to define four sides of a rectangular active sprite area that bounds said rotated sprite with reference to said unrotated sprite.

14. The system of claim 1 wherein said sprite pipe utilizes a display HCount value and a display VCount value to determine when to insert said rotated sprite in main display data on a display device.

15. The system of claim 1 wherein said sprite pipe detects that a vertical display enable and a horizontal display enable are both activated to responsively display said rotated sprite, a main display pipe displaying main display data when at least one of said vertical display enable and said horizontal display enable are not activated.

16. The system 1 wherein said sprite pipe performs a backward rotation procedure upon said rotated sprite to produce a backward rotated sprite, said backward rotation procedure aligning source pixels of said backward rotated sprite with target pixels of main display data on a display device.

17. The system of claim 1 wherein said sprite pipe performs a rendering procedure to produce final output pixels by rounding non-integer source pixels values to respective nearest integer values.

18. The system of claim 1 wherein said sprite pipe performs a rendering procedure to produce final output pixels by calculating weighted sums of respective adjacent source pixels.

19. The system of claim 18 wherein said rendering procedure includes utilizing separate color functions for calculating individual color components of said final output pixels.

20. The system of claim 1 wherein said sprite pipe recalculates a vertical display enable parameter, a horizontal display enable parameter, a vertical image generation parameter, and a horizontal image generation parameter for a rectangular active sprite area each time said selectable arbitrary rotation angle is altered, said selectable arbitrary rotation angle being freely selectable from any angle between zero degrees and 360 degrees.

21. A method for performing sprite rotation procedures in an electronic device, comprising the steps of:
storing an unrotated sprite into a sprite memory by utilizing an input module; and
performing said sprite rotation procedures upon said unrotated sprite by utilizing a sprite pipe to produce a rotated sprite at a selectable arbitrary rotation angle with respect to said unrotated sprite.

22. The method of claim 21 wherein said input module and said sprite pipe are implemented in a display controller that coordinates providing image data to a display device, said display controller being implemented as an integrated circuit device that functions as an interface between a central processing unit and said display device.

23. The method of claim 21 wherein said sprite pipe provides said rotated sprite to a data destination that includes a display for a portable electronic device.

24. The method of claim 23 wherein said portable electronic device is implemented as a portable cellular telephone device.

25. The method of claim 21 wherein said unrotated sprite and said rotated sprite represent a cursor inserted in main display data on a display device.

26. The method of claim 21 wherein said rotated sprite is rotated with respect to rotation point coordinates that are selectably positionable to be inside or outside of said unrotated sprite.

27. The method of claim 21 wherein said unrotated sprite and said rotated sprite represent a gaming object inserted in main display data on a display device.

28. The method of claim 21 wherein said sprite pipe sets a horizontal display enable and a vertical display enable for enabling said sprite rotation procedures in said electronic device.

29. The method of claim 21 wherein said sprite pipe calculates vertical display enable parameters that define vertical boundaries of a rectangular active sprite area with reference to main display data, said rectangular active sprite area encompassing said rotated sprite, said sprite pipe also calculating horizontal display enable parameters that define horizontal boundaries of said rectangular active sprite area.

30. The method of claim 21 wherein said sprite pipe calculates vertical image generation parameters that define vertical boundaries of a rectangular active sprite area with reference to said unrotated sprite, said rectangular active sprite area encompassing said rotated sprite, said sprite pipe also calculating horizontal image generation parameters that define horizontal boundaries of said rectangular active sprite area.

31. The method of claim 21 wherein said sprite pipe sets a rotation reference point for performing said sprite rotation procedures, said rotation reference point being set with reference to a lower left corner of said unrotated sprite, and with reference to a lower left corner of main display data.

32. The method of claim 21 wherein said sprite pipe calculates an XStartHDE parameter, an XEndHDE parameter, a YStartVDE parameter, and a YEndVDE parameter to define four sides of a rectangular active sprite area that bounds said rotated sprite with reference to main display data.

33. The method of claim 21 wherein said sprite pipe calculates an XStartIG parameter, an XEndIG parameter, a YStartIG parameter, and a YEndIG parameter to define four sides of a rectangular active sprite area that bounds said rotated sprite with reference to said unrotated sprite.

34. The method of claim 21 wherein said sprite pipe utilizes a display HCount value and a display VCount value to determine when to insert said rotated sprite in main display data on a display device.

35. The method of claim 21 wherein said sprite pipe detects that a vertical display enable and a horizontal display enable are both activated to responsively display said rotated sprite, a main display pipe displaying main display data when at least one of said vertical display enable and said horizontal display enable are not activated.

36. The method 21 wherein said sprite pipe performs a backward rotation procedure upon said rotated sprite to produce a backward rotated sprite, said backward rotation procedure aligning source pixels of said backward rotated sprite with target pixels of main display data on a display device.

37. The method of claim 21 wherein said sprite pipe performs a rendering procedure to produce final output pixels by rounding non-integer source pixels values to respective nearest integer values.

38. The method of claim 21 wherein said sprite pipe performs a rendering procedure to produce final output pixels by calculating weighted sums of respective adjacent source pixels.

39. The method of claim 38 wherein said rendering procedure includes utilizing separate color functions for calculating individual color components of said final output pixels.

40. The method of claim 21 wherein said sprite pipe recalculates a vertical display enable parameter, a horizontal display enable parameter, a vertical image generation parameter, and a horizontal image generation parameter for a rectangular active sprite area each time said selectable arbitrary rotation angle is altered, said selectable arbitrary rotation angle being freely selectable from any angle between zero degrees and 360 degrees.

41. A system for performing sprite rotation procedures in an electronic device, comprising:
means for storing an unrotated sprite into a sprite memory; and
means for performing said sprite rotation procedures upon said unrotated sprite to produce a rotated sprite at a selectable arbitrary rotation angle with respect to said unrotated sprite.
